(19) United States
(12) Patent Application Publication
(10) Pub. No.: US 2019/0072978 A1
(43) Pub. Date: Mar. 7, 2019

(54) METHODS AND SYSTEMS FOR GENERATING REALTIME MAP INFORMATION

(71) Applicant: GM GLOBAL TECHNOLOGY OPERATIONS LLC, Detroit, MI (US)

(72) Inventor: Dan Levi, Kyriat Ono (IL)

(73) Assignee: GM GLOBAL TECHNOLOGY OPERATIONS LLC, Detroit, MI (US)

(21) Appl. No.: 15/693,944

(22) Filed: Sep. 1, 2017

(51) Int. Cl. G05D 1/02; G06T 17/05; G06K 9/00; G06N 3/08

(52) U.S. Cl. CPC G05D 1/0274; G06T 17/05; G05D 2201/0213; G05D 1/0246; G06N 3/08; G06K 9/00791

(57) ABSTRACT

Systems and method are provided for generating map information in an autonomous vehicle. In one embodiment, a method includes: receiving image data associated with an environment of the autonomous vehicle; receiving object data associated with detected objects within the environment of the autonomous vehicle; processing the image data, the object data, and road level information using a deep learning network to obtain a first map, wherein the first map is in image coordinates; processing the first map with a second map in geographic coordinates to generate a maplet; and controlling the autonomous vehicle based on the maplet.

### INTRODUCTION

The present disclosure generally relates to autonomous vehicles, and more particularly relates to systems and methods for constructing a lane representation in realtime for use in controlling an autonomous vehicle.

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

While recent years have seen significant advancements in autonomous vehicles, such vehicles might still be improved in a number of respects. For example, in some instances, automated driving is based on survey-level pre-mapping of the area. That is, surveys of the area are performed, high definition maps are assembled from the survey data using human intervention, and the high definition maps are communicated to the vehicle for use. According to this process, an autonomous vehicle is constrained to the mapped area, whether or not the mapped area has changed from the time of survey.

Accordingly, it is desirable to provide improved systems and methods for constructing map information including a lane representation in realtime. It is further desirable to make use of the constructed map information in controlling an autonomous vehicle. Furthermore, other desirable features and characteristics of the present disclosure will become apparent from the subsequent detailed description and the appended claims, taken in conjunction with the accompanying drawings and the foregoing technical field and background.

### SUMMARY

Systems and method are provided for generating map information in an autonomous vehicle. In one embodiment, a method includes: receiving image data associated with an environment of the autonomous vehicle; receiving object data associated with detected objects within the environment of the autonomous vehicle; processing the image data, the object data, and road level information using a deep learning network to obtain a first map, wherein the first map is in image coordinates; processing the first map with a second map in geographic coordinates to generate a maplet; and controlling the autonomous vehicle based on the maplet.

In one embodiment, a system includes a processor. The system further includes a first non-transitory module that, by the processor, receives image data associated with an environment of the autonomous vehicle, and that receives object data associated with detected objects within the environment of the autonomous vehicle; a second non-transitory module that, by the processor, processes the image data, the object data, and road level information using a deep learning network to obtain a first map, wherein the first map is in image coordinates; a third non-transitory module that, by the processor, processes the first map with a second map in geographic coordinates to generate a maplet; and a fourth non-transitory module, that by the processor, controls the autonomous vehicle based on the maplet.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having a realtime mapping system, in accordance with various embodiments;

FIG. 2 is a functional block diagram illustrating a transportation system having one or more autonomous vehicles of FIG. 1, in accordance with various embodiments;

FIGS. 3 and 4 are dataflow diagrams illustrating an autonomous driving system that includes the realtime mapping system of the autonomous vehicle, in accordance with various embodiments; and

FIGS. 5 and 6 are illustrations of an exemplary mid-level map and an exemplary maplet in accordance with various embodiments; and

FIG. 7 is a flowchart illustrating a control method for constructing map information in realtime and controlling the autonomous vehicle, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

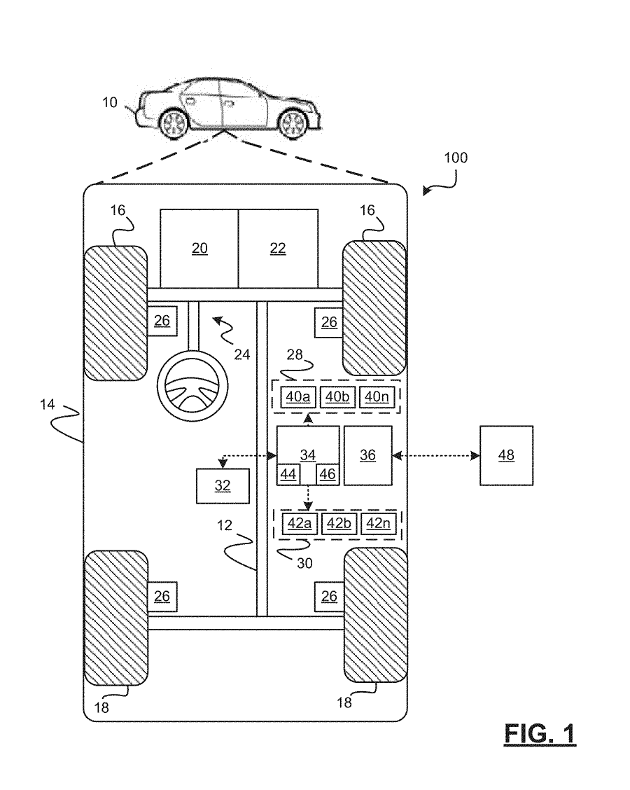

With reference to FIG. 1, a realtime mapping system shown generally at 100 is associated with a vehicle 10 in accordance with various embodiments. In general, the realtime mapping system 100 constructs map information in realtime and intelligently controls the vehicle 10 based thereon. As used herein, the term realtime means at or during the time the autonomous vehicle is operational and making use of map information. In various embodiments, the map information produced by the realtime mapping system 100 includes a realtime lane representation.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the realtime mapping system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, inertial measurement units, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

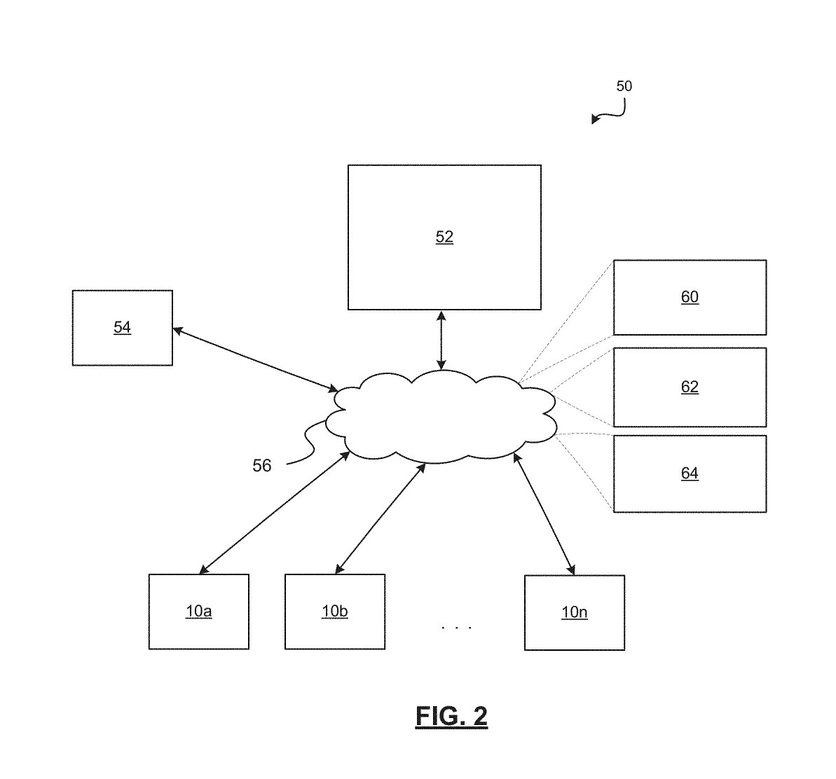

The communication system 36 is configured to wirelessly communicate information to and from other entities 48, such as but not limited to, other vehicles (“V2V” communication) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the autonomous vehicle 10 (wirelessly and/or in a wired manner) and stored in the data storage device 32. In various embodiments, the defined maps are two dimensional maps. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the realtime mapping system 100 and, when executed by the processor 44, process sensor data from the sensor system and map data from the data storage device using deep learning techniques in order to produce realtime map information in controlling the vehicle.

With reference now to FIG. 2, in various embodiments, the autonomous vehicle 10 described with regard to FIG. 1 may be suitable for use in the context of a taxi or shuttle system in a certain geographical area (e.g., a city, a school or business campus, a shopping center, an amusement park, an event center, or the like) or may simply be managed by a remote system. For example, the autonomous vehicle 10 may be associated with an autonomous vehicle based remote transportation system. FIG. 2 illustrates an exemplary embodiment of an operating environment shown generally at 50 that includes an autonomous vehicle based remote transportation system 52 that is associated with one or more autonomous vehicles 10a-10n as described with regard to FIG. 1. In various embodiments, the operating environment 50 further includes one or more user devices 54 that communicate with the autonomous vehicle 10 and/or the remote transportation system 52 via a communication network 56.

The communication network 56 supports communication as needed between devices, systems, and components supported by the operating environment 50 (e.g., via tangible communication links and/or wireless communication links). For example, the communication network 56 can include a wireless carrier system 60 such as a cellular telephone system that includes a plurality of cell towers (not shown), one or more mobile switching centers (MSCs) (not shown), as well as any other networking components required to connect the wireless carrier system 60 with a land communications system. Each cell tower includes sending and receiving antennas and a base station, with the base stations from different cell towers being connected to the MSC either directly or via intermediary equipment such as a base station controller. The wireless carrier system 60 can implement any suitable communications technology, including for example, digital technologies such as CDMA (e.g., CDMA2000), LTE (e.g., 4G LTE or 5G LTE), GSM/GPRS, or other current or emerging wireless technologies. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from including the wireless carrier system 60, a second wireless carrier system in the form of a satellite communication system 64 can be included to provide uni-directional or bi-directional communication with the autonomous vehicles 10a-10n. This can be done using one or more communication satellites (not shown) and an uplink transmitting station (not shown). Uni-directional communication can include, for example, satellite radio services, wherein programming content (news, music, etc.) is received by the transmitting station, packaged for upload, and then sent to the satellite, which broadcasts the programming to subscribers. Bi-directional communication can include, for example, satellite telephony services using the satellite to relay telephone communications between the vehicle 10 and the station. The satellite telephony can be utilized either in addition to or in lieu of the wireless carrier system 60.

A land communication system 62 may further be included that is a conventional land-based telecommunications network connected to one or more landline telephones and connects the wireless carrier system 60 to the remote transportation system 52. For example, the land communication system 62 may include a public switched telephone network (PSTN) such as that used to provide hardwired telephony, packet-switched data communications, and the Internet infrastructure. One or more segments of the land communication system 62 can be implemented through the use of a standard wired network, a fiber or other optical network, a cable network, power lines, other wireless networks such as wireless local area networks (WLANs), or networks providing broadband wireless access (BWA), or any combination thereof. Furthermore, the remote transportation system 52 need not be connected via the land communication system 62, but can include wireless telephony equipment so that it can communicate directly with a wireless network, such as the wireless carrier system 60.

Although only one user device 54 is shown in FIG. 2, embodiments of the operating environment 50 can support any number of user devices 54, including multiple user devices 54 owned, operated, or otherwise used by one person. Each user device 54 supported by the operating environment 50 may be implemented using any suitable hardware platform. In this regard, the user device 54 can be realized in any common form factor including, but not limited to: a desktop computer; a mobile computer (e.g., a tablet computer, a laptop computer, or a netbook computer); a smartphone; a video game device; a digital media player; a piece of home entertainment equipment; a digital camera or video camera; a wearable computing device (e.g., smart watch, smart glasses, smart clothing); or the like. Each user device 54 supported by the operating environment 50 is realized as a computer-implemented or computer-based device having the hardware, software, firmware, and/or processing logic needed to carry out the various techniques and methodologies described herein. For example, the user device 54 includes a microprocessor in the form of a programmable device that includes one or more instructions stored in an internal memory structure and applied to receive binary input to create binary output. In some embodiments, the user device 54 includes a GPS module capable of receiving GPS satellite signals and generating GPS coordinates based on those signals. In other embodiments, the user device 54 includes cellular communications functionality such that the device carries out voice and/or data communications over the communication network 56 using one or more cellular communications protocols, as are discussed herein. In various embodiments, the user device 54 includes a visual display, such as a touch-screen graphical display, or other display.

The remote transportation system 52 includes one or more backend server systems, which may be cloud-based, network-based, or resident at the particular campus or geographical location serviced by the remote transportation system 52. The remote transportation system 52 can be manned by a live advisor, or an automated advisor, or a combination of both. The remote transportation system 52 can communicate with the user devices 54 and the autonomous vehicles 10a-10n to schedule rides, dispatch autonomous vehicles 10a-10n, and the like. In various embodiments, the remote transportation system 52 stores account information such as subscriber authentication information, vehicle identifiers, profile records, behavioral patterns, and other pertinent subscriber information.

In accordance with a typical use case workflow, a registered user of the remote transportation system 52 can create a ride request via the user device 54. The ride request will typically indicate the passenger's desired pickup location (or current GPS location), the desired destination location (which may identify a predefined vehicle stop and/or a user-specified passenger destination), and a pickup time. The remote transportation system 52 receives the ride request, processes the request, and dispatches a selected one of the autonomous vehicles 10a-10n (when and if one is available) to pick up the passenger at the designated pickup location and at the appropriate time. The remote transportation system 52 can also generate and send a suitably configured confirmation message or notification to the user device 54, to let the passenger know that a vehicle is on the way.

As can be appreciated, the subject matter disclosed herein provides certain enhanced features and functionality to what may be considered as a standard or baseline autonomous vehicle 10 and/or an autonomous vehicle based remote transportation system 52. To this end, an autonomous vehicle and autonomous vehicle based remote transportation system can be modified, enhanced, or otherwise supplemented to provide the additional features described in more detail below.

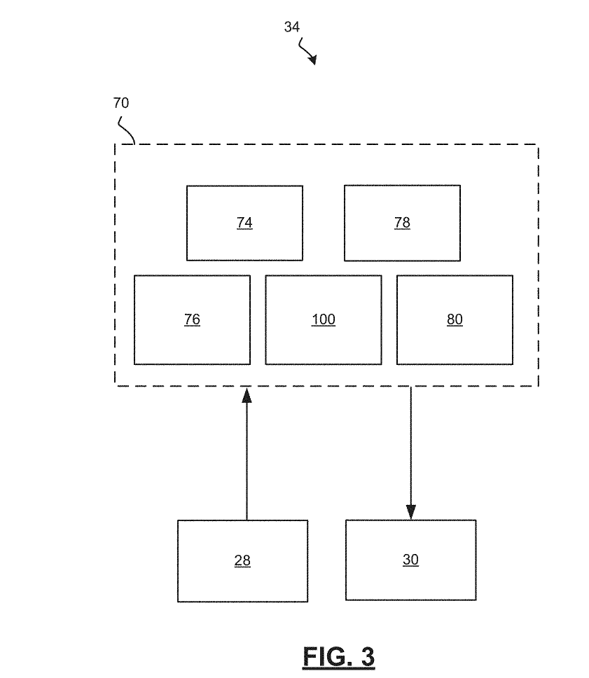

In accordance with various embodiments, the controller 34 implements an autonomous driving system (ADS) 70 as shown in FIG. 3. That is, suitable software and/or hardware components of the controller 34 (e.g., the processor 44 and the computer-readable storage device 46) are utilized to provide an autonomous driving system 70 that is used in conjunction with vehicle 10.

In various embodiments, the instructions of the autonomous driving system 70 may be organized by function, module, or system. For example, as shown in FIG. 3, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, path, and/or motion of objects and features of the environment of the vehicle 10. In various embodiments, the computer vision system 74 can incorporate information from multiple sensors, including but not limited to cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. A variety of techniques may be employed to accomplish this localization, including, for example, simultaneous localization and mapping (SLAM), particle filters, Kalman filters, Bayesian filters, and the like.

The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

As mentioned briefly above, the realtime mapping system 100 of FIG. 1 is included within the ADS 70 as a separate system (as shown) or as part of one of the other systems 74-80. In various embodiments, when implemented as a separate system (as shown), the realtime mapping system 100 receives data from the computer vision system 74, and from the data storage device 32, and provides map information to the guidance system 78.

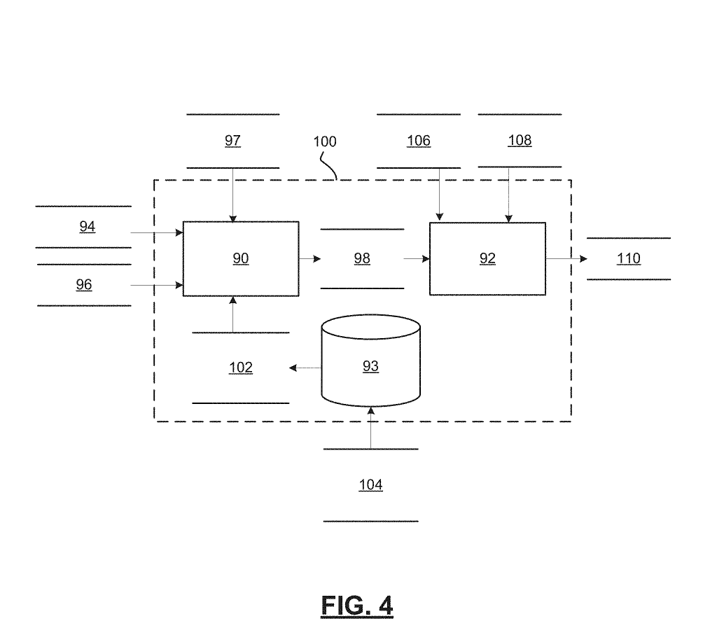

For example, as shown in more detail with regard to FIG. 4 and with continued reference to FIG. 3, the realtime mapping system 100 includes a mid-level topology generation module 90, a maplet generation module 92, and a network datastore 93.

The mid-level topology generation module 90 receives as input image data 94, object data 96, and road level map data 97. The image data 94 includes a fused image of the current environment surrounding the vehicle 10 from data produced by the camera system. The image data is provided according to an image coordinate system that is relative to the vehicle 10. The object data 96 includes object types, object positions, and/or predicted motion of detected objects in the current environment. The object data 96 can be obtained from the computer vision system 74. The road level data 97 includes road information (e.g., in two dimensions) of the environment in proximity (e.g., within a mile's radius or other distance) to a rough position of the vehicle 10.

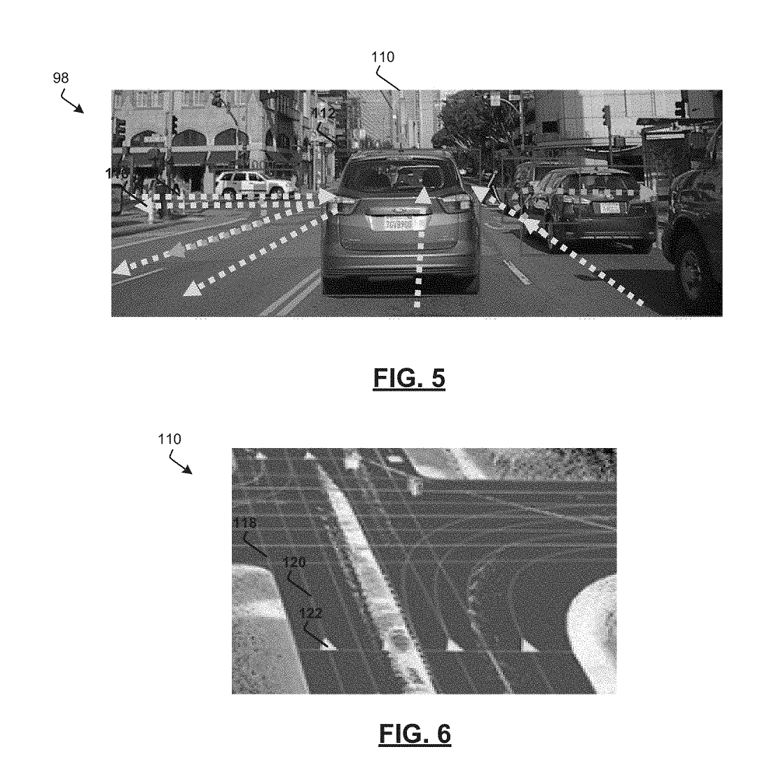

The mid-level topology generation module 90 processes the image data 94, and the object data 96 to determine a mid-level map 98. As shown in FIG. 5, an exemplary mid-level map 98 includes the image 110, objects 112 identified within the image 110 (for example as shown by the bounding boxes around the object), paths 114 identified within the image 110 (for example, as shown by the dashed lines), and path directions 116 (for example, as shown by the arrows associated with the dashed lines) associated with the identified paths 114. In various embodiments, the paths 114 can be identified as primary paths, alternate paths, etc. (for example, by varying the color of the line, the line type, etc.).

With reference back to FIG. 4, in accordance with various embodiments, the mid-level topology generation module 90 utilizes a trained deep neural network (DNN) 102 such as, but not limited to, a convolutional neural network (CNN) or other DNN to generate the mid-level map. For example, in one embodiment, a generative adversarial network including two neural networks, a generative network and a discriminative network can be implemented. The discriminative network can be trained with data in a supervised or unsupervised mode by presenting it with a large number (i.e., a “corpus”) of labeled (i.e., pre-classified) input images that include a range of objects and lane/path configurations. The generator network can be seeded with random input. Backpropagation is then used to refine the training of the two networks. The resulting networks 104 are then stored in the network datastore 93 and used by mid-level topology generation module 90 as the trained deep neural network 102 to produce the mid-level map 98. In particular, during normal operation, the trained GAN is used to process the image data 94, the object data 96, and the road level data 97 received as the vehicle 10 moves through the environment and observes objects, paths, and path directions. The trained GAN then produces the mid-level map 98 based on the observed objects, paths, and path directions.

In various embodiments, the maplet generation module 92 receives the mid-level map 98, map data 106, and position data 108. In various embodiments, the map data 108 includes a two dimensional map of the environment in proximity (e.g., within a mile's radius or other distance) to the vehicle 10. The position data 106 includes a rough position of the vehicle 10 relative to the two dimensional map.

The maplet generation module 92 generates a three dimensional (3D) maplet 110 from the map data 108, the position data 106, and the information of the mid-level map 98. In various embodiments, as shown in FIG. 6, the 3D maplet 110 includes lane boundaries 118, and the various paths 120 and path directions 122 mapped to a 3D space. For example, the maplet generation module 92 maps the current position of the vehicle 10 to the two-dimensional map, and then maps information from the mid-level map 98 to the two-dimensional map based on the current position of the vehicle 10 and the coordinates of the mid-level map 98 relative to the vehicle 10. The information from the mid-level map 98 is then translated into three dimensional space to produce the 3D maplet 110 of the current environment.

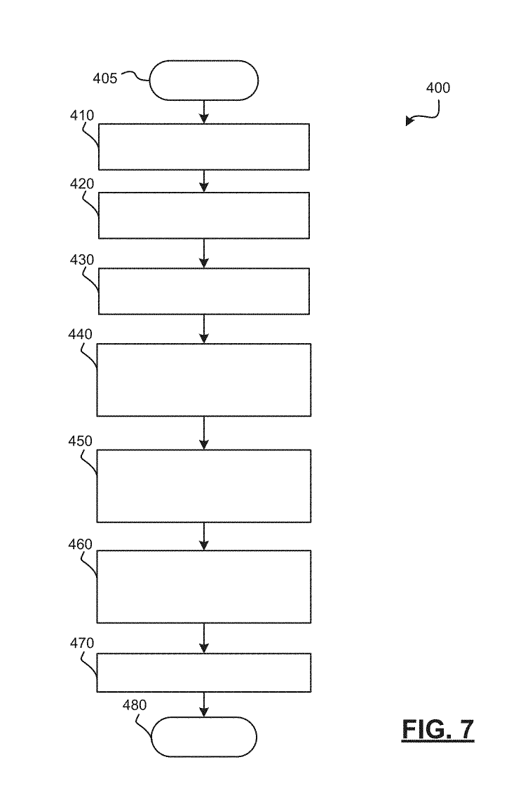

Referring now to FIG. 7, and with continued reference to FIGS. 1-6, a flowchart illustrates a control method 400 that can be performed by the realtime mapping system 100 of FIG. 1 in accordance with the present disclosure. As can be appreciated in light of the disclosure, the order of operation within the method is not limited to the sequential execution as illustrated in FIG. 7, but may be performed in one or more varying orders as applicable and in accordance with the present disclosure. In various embodiments, the method 400 can be scheduled to run based on one or more predetermined events, and/or can run continuously during operation of the autonomous vehicle 10.

In one embodiment, the method may begin at 405. The image data 94 is received from the camera system of the vehicle 10 and processed at 410. The object data 96 is determined from the image data and/or other sensor data at 420. The trained deep neural network 102 is retrieved from the network datastore 93 at 430. The image data 94, the object data 96, and the road level data 97 are processed with the deep neural network 102 at 440 to produce the mid-level map 98. The mid-level map 98 is mapped to the two dimensional map from the map data 108 based on the vehicle position from the position data 106. The two dimensional map is translated to a three dimensional map to form the realtime 3D maplet 110 at 460. Thereafter, the vehicle 10 is autonomously controlled based on the realtime 3D maplet 110 at 470; and the method may end at 480.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for generating map information in an autonomous vehicle, comprising:
receiving image data associated with an environment of the autonomous vehicle;
receiving object data associated with detected objects within the environment of the autonomous vehicle;
processing the image data, the object data, and road level information using a deep learning network to obtain a first map, wherein the first map is in image coordinates;
processing the first map with a second map in geographic coordinates to generate a maplet; and
controlling the autonomous vehicle based on the maplet.

2. The method of claim 1, wherein the first map includes identified objects, identified paths, and identified path directions.

3. The method of claim 1, wherein the second map is a two dimensional map.

4. The method of claim 3, wherein the maplet is a three dimensional map.

5. The method of claim 1, wherein the maplet includes a lane configuration, path identifiers, and path directions.

6. The method of claim 1, wherein the deep learning network is a convolutional neural network.

7. The method of claim 6, wherein the deep learning network is a generative adversarial network.

8. The method of claim 1 wherein the processing the first map with the second map is based on a position of the autonomous vehicle relative to the second map.

9. The method of claim 1, wherein the image coordinates are relative to the autonomous vehicle.

10. A system for generating map information in an autonomous vehicle, comprising:
a processor; and
a first non-transitory module that, by the processor, receives image data associated with an environment of the autonomous vehicle, and that receives object data associated with detected objects within the environment of the autonomous vehicle;
a second non-transitory module that, by the processor the image data, the object data, and road level information using a deep learning network to obtain a first map, wherein the first map is in image coordinates;
a third non-transitory module that, by the processor, processes the first map with a second map in geographic coordinates to generate a maplet; and
a fourth non-transitory module, that by the processor, controls the autonomous vehicle based on the maplet.

11. The system of claim 10, wherein the first map includes identified objects, identified paths, and identified path directions.

12. The system of claim 10, wherein the second map is a two dimensional map.

13. The system of claim 12, wherein the maplet is a three dimensional map.

14. The system of claim 10, wherein the maplet includes a lane configuration, path identifiers, and path directions.

15. The system of claim 10, wherein the deep learning network is a convolutional neural network.

16. The system of claim 15, wherein the deep learning network is a generative adversarial network.

17. The system of claim 10, wherein the third non-transitory module processes the first map with the second map based on a position of the autonomous vehicle relative to the second map.

18. The system of claim 10, wherein the image coordinates are relative to the autonomous vehicle.

19. A method for generating map information in an autonomous vehicle, comprising:
receiving image data associated with an environment of the autonomous vehicle;
receiving object data associated with detected objects within the environment of the autonomous vehicle;
processing the image data, the object data, and road level information using a deep learning network to obtain a first map, wherein the first map is in two dimensional image coordinates and identifies objects, paths, and path directions;
processing the first map with a second map in two dimensional geographic coordinates to generate a maplet, wherein the maplet is in three dimensional geographic coordinates, wherein the maplet identifies a lane configuration, path identifiers, and path directions; and
controlling the autonomous vehicle based on the maplet.

20. The method of claim 19, wherein the deep learning network is a generative adversarial network.
